(19) United States
(12) Patent Application Publication
(10) Pub. No.: US 2021/0209539 A1
(43) Pub. Date: Jul. 8, 2021

(54) SYSTEM FOR REFERRAL AND SALES LEAD MATCHING AND TRACKING

(71) Applicant: Goldmine World, Inc., Fairfax, VA (US)

(72) Inventor: Sung Bin Im, Oakton, VA (US)

(73) Assignee: Goldmine World, Inc., Fairfax, VA (US)

(21) Appl. No.: 17/055,615

(22) PCT Filed: May 14, 2019
(86) PCT No.: PCT/US19/32180

§ 371 Date: Nov. 16, 2020

Related U.S. Application Data
(60) Provisional application No. 62/671,353, filed on May 14, 2018.

(51) Int. Cl. G06Q 10/06; G06Q 30/02; G06Q 10/10

(52) U.S. Cl. CPC G06Q 10/063112; G06Q 10/103; G06Q 30/0205; G06Q 30/0201

(57) ABSTRACT

A system for receiving and automatically distributing sales leads includes a data store and a computer processor coupled to the data store and in communication through the Internet with a user device. The data store stores registered user data and sales lead data. The computer processor is programmed, upon receiving an indication from a referral agent that sales lead data is to be uploaded, to (i) serve a sales lead form via a web page or mobile application page to the referral agent via the Internet, the sales lead form comprising a plurality of data fields describing at least an identification of a prospective customer, an identification of goods or services to be purchased, and an identification of a geographic location of the prospective customer, (ii) receive and store in the data store sales lead data provided by the user via the sales lead form, (iii) automatically identify at least one sales agent to the sales lead data is to be distributed, (iv) automatically distribute, via the Internet, the sales lead data to the at least one sales agent identified, (v) track at least one sale associated with the sales lead data, and (vi) display at least one indication to a user that a sale of goods or services associated with the sales lead data has been made.

This Application is a non-provisional of U.S. Provisional Patent Application No. 62/671,353 filed May 14, 2018, the entire disclosure of which is incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present invention relates in general to the field of management systems, and in particular to a system that uses a web portal to receive and distribute sales lead or referral data. In an embodiment, the problem to be solved is that computerized sales management systems do not provide critical timely data on sales and referral leads to the computing device of the most efficient sales agent, do not provide sufficient ease-of-use for all user types, and do not incentivize exchange of sales and referral lead data.

### SUMMARY

The present system and method provides a web-accessible portal that provides sales lead matching and tracking that can be used by at least four user types—referral agents, sales agents, merchants and administrators. In an embodiment, the invention provides a web portal which allows referral agents to upload sales leads to the system. The system is configured to prompt the referral agent for multiple discrete data fields associated with a particular lead, including geographic location of the sales lead. The present system then automatically distributes each sales lead to a sales agent. In determining the sales agent(s) that should receive a particular sales lead, the system can use multiple data fields associated with the sales lead as factors in the determination. The system may, for example, calculate a proximity or geographic distance between the geographic location of the sales lead and the geographic location of the sales agent. In an embodiment, the system factors in past performance of sales agents in making the determination. For example, the system may be configured to distribute a sales lead to the highest performing sales agent within a particular geographic area that qualifies as a sales territory for the sales lead. Performance of a particular sales agent may be determined in quantitative terms such as number of sales closed by the agent within a given time period, speed of response of the agent, dollar value of sales closed by the agent, and number of sales leads previously generated by the agent as a referral agent.

The system can be configured to track sales revenue from sales referred by the system and, in an embodiment, determine sharing of such sales revenue between the sales agent, the company employing the sales agent, and the referral agent. In an embodiment, the system is additionally configured to determine sharing of such sales revenue with a company employing the referral agent, with a company operating the presently disclosed system, with a third party associated with the referral agent, and/or a third party associated with the sales agent. The referral agent may be associated with or unassociated with the sales agent, the company employing the sales agent, the referral agent, the company operating the system, and the third party. In this respect, the system can allow friends and family of any of these parties to direct leads to the system and receive compensation for such leads if it results in a sale. The system can be configured to direct compensation to any of the parties in monetary form or in non-monetary form, such as in loyalty points. The system can be configured to charge the sales agent for the lead at a preset cost set by an administrator, or the system may direct the sales lead to a particular sales agent, or group of sales agents, in accordance with an online auction system wherein sales agents or other users can bid for leads. The system can be configured to compensate the referral agent by regular installments as a portion of the revenue generated by the resulting sale or by a one-time compensation. The present invention can provide the benefit of increased hot and/or very warm leads to any organization that relies on sales revenue.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 shows a flow chart illustrating a process for referral and sales lead matching in accordance with an embodiment of the invention.

FIG. 2 shows a block diagram of a data processing system that can be used in various embodiments of the disclosed systems and methods.

FIG. 3 shows a block diagram of a user device.

### DETAILED DESCRIPTION

Reference will now be made in detail to the preferred embodiments of the present invention, examples of which are illustrated in the accompanying drawings. The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

In an embodiment, the present invention provides a server that provides a website and mobile application system that is configured to automatically receive and track referrals and sales leads from start to finish, and allows merchants to become customers of the operator of the system.

The invention provides a portal that includes two parts, one for agents (Referral and Sales) and one for merchants (customers). The server is configured to provide, through a web site and/or mobile application, a registration process that allows new users to register to become referral agents. The registration process executed by the server allows users to submit documentation online and process applications seamlessly to allow quick approvals. Once a user is accepted as a registered referral agent, they are able to upload Sales Leads (Referrals) to the system through a referral form or in bulk in the form of a spreadsheet created by a program such as Microsoft Excel or in other suitable form for importation into the present system's database.

The server is further configured to provide the website and/or mobile application with the capability to allow new users to apply to become Sales Agents. For example, new users are able to access the website and upload resumes and other required documents to become a sales agent. After verification of their data, an administrator or an automated process may select them to be eligible to become Sales Agents. Initially, such eligible applicants are designated by the system as trainees and, after successful completion of training, they are promoted by the system, either automatically or with administrator intervention, to Sales Agents.

The system provides lead distribution automation that allows Sales Leads to be received and automatically distributed based on various factors that can be setup within the system. In an embodiment, each Sales agent is assigned Sales Leads based on Proximity and Conversion Ratio, along with other factors. Although, the distribution is automated, the system can be configured to allow Administrators to overwrite and assign particular leads to certain agents. Once a Sales Lead is assigned to a Sales Agent, the system provides the Sales Agent with the contact information and business information associated with the lead as provided by the referral agent.

With respect to Merchants who wish to sign up for services with the company operating the present system (e.g., customers who wish to sign up for credit card processing service with a company that provides credit card processing services), the system can be configured to use a Price Matrix that takes various parameters and provides a grid-like interface to allow setting of various rates with such Merchants, either with or without a Sales Agent involved. The price matrix allows the Merchant to pick a level of service in accordance with factors such as the number of credit card transactions per month that they expect to submit for processing, average transaction size in dollars, method of accepting (card present, card not present, etc.) and obtain a price quotation for that level of service. The price quotation may be a percentage of the transaction amount, a set fee, or a combination of these. The system may also be configured to provide a parameter for profit percentage limitations that administrators of the system are able to setup. The portal can provide this tool directly to Merchants so that they can sign up for credit card processing services (or other services) directly without a Sales Agent being involved.

Sales Agents can also use the above tool in their negotiations with potential customers from the Sales Leads. Once a price is settled by both the agent and potential customer, Sales Agents are able to submit documents on behalf of the customer to sign up for various services, such as card processing.

After the Sales Agent closes a sale in accordance with a lead provided by the system, the system provides an online process by which the Sales Agent or his representative can upload to the system the sales data or contract associated with the sale. The system can be configured to proceed with compensation to the Referral Agent, or otherwise notify the Referral Agent, upon receipt of such sales data or contract. In the case where the contract is a contract for card processing services, the sales cycle may be considered complete when the customer begins using such services. The system can be configured to compensate the sales agent by regular installments as a portion of the revenue generated by the resulting sale. For example, where the sale is a contract for card processing services, the system can be configured to compensate the sales agent by a percentage of the monthly revenue to the card processor from the contract.

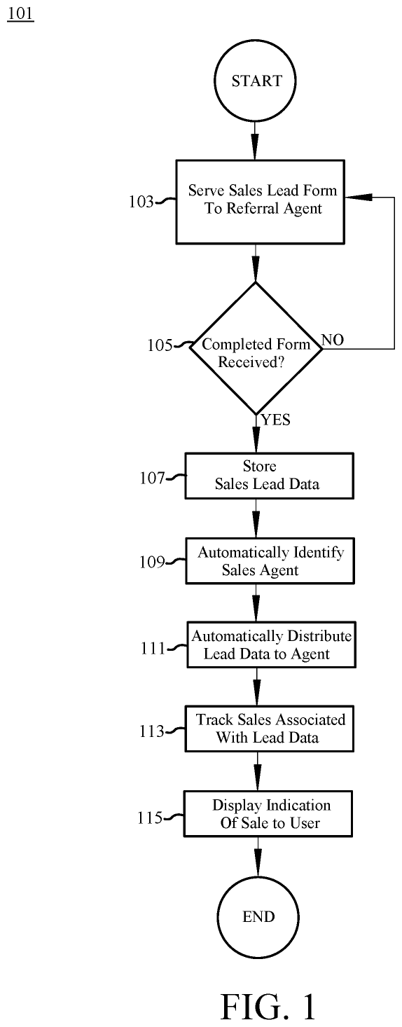

FIG. 1 shows an embodiment of a process for operating a system for receiving and automatically distributing sales leads in accordance with an embodiment. The system includes a data store having therein registered user data and sales lead data. The system further includes a computer processor coupled to the data store and in communication through the Internet with a user device. The computer processor is programmed, upon receiving an indication from a referral agent that sales lead data is to be uploaded, to execute a series of steps 101. At step 103, the system serves a sales lead form via a web page or mobile application page to the referral agent via the Internet. The sales lead form includes data fields describing an identification of a prospective customer, an identification of goods or services to be purchased, and an identification of a geographic location of the prospective customer.

At step 105, the system receives a sales lead form from the user and determines whether the form is complete. If the sales lead form is not complete, the system serves further sales lead form data to the user. If the sales lead form received is complete, the system proceeds to step 107 and stores, in the data store, sales lead data provided by the user via the sales lead form.

At step 109, the system automatically identifies at least one sales agent to which the sales lead data is to be distributed. The system then, at step 111, automatically distributes, via the Internet, the sales lead data to the sales agent (or agents) that were identified in step 109.

At step 113, the system tracks, over time, sales associated with the sales lead data. At step 115, the system displays to a user an indication that one or more sales of goods or services associated with the sales lead data have been made.

In an embodiment, the invention provides an automated process for new users to register to become Card Processing Merchants of the website. The system is configured to guide the user through various fields that must be filled in and uploading documentation that is required. The system provides e-signature support to allow processing of applications online. The system is configured to use the above-described Price Matrix tool to present Merchants with a customized card processing rate quote specific to the information that they inputted previously into the system. Fields such as Business Type, Monthly Volume, Average Ticket Size, and other fields provide the Price Matrix with the necessary data it needs to be able to process a Rate Quotation for each merchant. Once a merchant agrees with the suggested Rate Quotation, the system proceeds to collect necessary e-signatures for required documentation. The system is configured to guide the Merchant if any documents are missing and help them to submit everything that is needed until final administrator approval.

The invention can provide an online portal through which a merchant can register themselves to become a Card Processing Merchant. The system can be configured to provide the merchant with the necessary forms for becoming authorized to provide credit card processing services, submit the application, and manage the extensive approval process, all in a fully automated online system. In this respect, the system may be provided with the ability to accept electronic signatures in such forms. In the case where a merchant does not want to fill out the forms to become a Card Processing Merchant, but still desires to provide card processing services, the present invention can provide a portal by which an authorized Sales Agent can fill out the forms required on behalf of the merchant in exchange for a monetary or non-monetary benefit provided to the Sales Agent. The portal described above can be configured to allow such merchant to chat with such Sales Agent and request that the Sales Agent fill out the necessary forms. In this respect, the presently described system can be an intermediary between the provider of card processing services and a merchant who wishes to obtain or offer card processing services but does not have the expertise to manage the complex card processing application process. The system can provide a fully automated facility to allow online submission of the numerous forms required and management of the steps between submission of the application and the commencement of card processing services by the merchant.

In an embodiment, the server is configured to incorporate into the website and/or mobile application an online shopping mall for users to be able to purchase new equipment and services. Each new service has associated with it an automated workflow that generates the proper documentation and guides the user on each step of the approval process. For example, ATM purchases can be accompanied by necessary ATM documentation and instructions on what supporting documents need to be uploaded. It provides Merchants with options such as online payment or a leasing program with various pricing based on approved credit levels. The online shopping mall may also include Point of Sale products with instructions on the necessary documentation and supporting documents to purchase these products. The server may be configured to provide an online shopping mall that allows sales agents and/or their associated companies to purchase sales leads, and may further be configured to allow customers or other users of the system to purchase goods and services associated with the sales lead. For example, if the sales lead relates to point-of-sale (POS) equipment or services, the server may provide an online shopping mall that allows users to purchase terminals, ATM parts, and POS devices. Prices for such equipment or services may be a set price set by an administrator or may be set in accordance with an online auction system wherein users can bid for leads.

Alternatively or in addition to the online shopping mall described above, the system can provide an online sales lead market in which users can purchase sales leads or bid to acquire sales leads.

In an embodiment, the invention can provide all users with dashboards that are linked to the main system and allow display of status of documents submitted and pending actions that need to be taken by either the Merchant, Agent, or Administrator. Administrators are able to oversee all aspects of the system and change various parameters. User security and user roles will be maintained by the Admin as well.

Any type of company can use or provide the processes or systems described above. Non-limiting examples of such users or providers include, e.g., credit card processors, phone service providers, insurance companies, and mortgage companies.

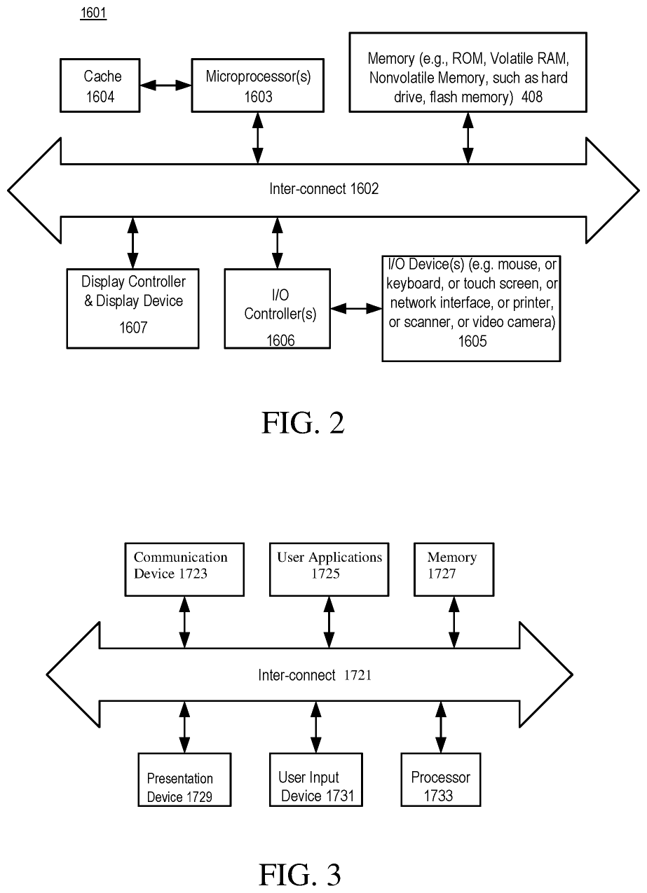

FIG. 2 shows a block diagram of a data processing system that can be used in various embodiments of the disclosed systems and methods. While FIG. 2 illustrates various components of a computer system, it is not intended to represent any particular architecture or manner of interconnecting the components. Other systems that have fewer or more components may also be used.

In FIG. 2, the system 1601 includes an inter-connect 1602 (e.g., bus and system core logic), which interconnects a microprocessor(s) 1603 and memory 1608. The microprocessor 1603 is coupled to cache memory 1604 in the example of FIG. 2.

The inter-connect 1602 interconnects the microprocessor(s) 1603 and the memory 1608 together and also interconnects them to a display controller and display device 1607 and to peripheral devices such as input/output (I/O) devices 1605 through an input/output controller(s) 1606. Typical I/O devices include mice, keyboards, modems, network interfaces, printers, scanners, video cameras and other devices that are well known in the art.

The inter-connect 1602 may include one or more buses connected to one another through various bridges, controllers and/or adapters. In one embodiment the I/O controller 1606 includes a USB (Universal Serial Bus) adapter for controlling USB peripherals, and/or an IEEE-1394 bus adapter for controlling IEEE-1394 peripherals.

The memory 1608 may include ROM (Read-Only Memory) and volatile RAM (Random Access Memory), and non-volatile memory data store, such as hard drive, flash memory, etc. Volatile RAM is typically implemented as dynamic RAM (DRAM) that requires power continually in order to refresh or maintain the data in the memory. Non-volatile memory data store is typically a magnetic hard drive, a magnetic optical drive, or an optical drive (e.g., a DVD RAM), or other type of memory system which maintains data even after power is removed from the system. The non-volatile memory data store may also be a random access memory. The non-volatile memory data store can be a local device coupled directly to the rest of the components in the data processing system. A non-volatile memory data store that is remote from the system, such as a network storage device coupled to the data processing system through a network interface such as a modem or Ethernet interface, can also be used.

In an embodiment, one or more servers supporting the platform are implemented using one or more data processing systems as illustrated in FIG. 2. In an embodiment, user devices such as those used to access the user interfaces described above are implemented using one or more data processing system as illustrated in FIG. 2.

In some embodiments, one or more servers of the system illustrated in FIG. 2 are replaced with the service of a peer-to-peer network or a cloud configuration of a plurality of data processing systems, or a network of distributed computing systems. The peer-to-peer network, or cloud-based server system, can be collectively viewed as a server data processing system.

Embodiments of the system disclosed above can be implemented via the microprocessor(s) 1603 and/or the memory 1608. For example, the functionalities described above can be partially implemented via hardware logic in the microprocessor(s) 1603 and partially using the instructions stored in the memory 1608. Some embodiments are implemented using the microprocessor(s) 1603 without additional instructions stored in the memory 1608. Some embodiments are implemented using the instructions stored in the memory 1608 for execution by one or more general-purpose microprocessor(s) 1603. Thus, the disclosure is not limited to a specific configuration of hardware and/or software.

FIG. 3 shows a block diagram of a user device. In FIG. 3, the user device includes an inter-connect 1721 connecting a communication device 1723, such as a network interface device, a presentation device 1729, such as a display screen, a user input device 1731, such as a keyboard or touch screen, user applications 1725 implemented as hardware, software, firmware or a combination of any of such media, such various user applications (e.g. apps), a memory/data store 1727, such as RAM or magnetic storage, and a processor 1733 that, inter alia, executes the user applications 1725.

In one embodiment, the user applications implement one or more user interfaces displayed on the presentation device 1729 that provides users and the system the capabilities to, for example, access a Wide Area Network (WAN) such as the Internet, and display and interact with user interfaces provided by the platform, such as, for example the user interfaces described above in this disclosure. In an embodiment, users use the user input device 1731 to interact with the device via the user applications 1725 supported by the device.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

Thus, there has been disclosed above a system that uses a web portal to receive and distribute sales lead or referral data that achieves substantial benefits over conventional customer management systems, such as increased flexibility, faster distribution of data on sales and referral leads to the computing device of the most efficient sales agent, lower local processing overhead and lower user error in connection with execution of sales leads.

Reference in this specification to “an embodiment” or “the embodiment” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention is described above with reference to block diagrams and operational illustrations of methods and devices to receive and distribute sales leads. It is understood that each block of the block diagrams or operational illustrations, and combinations of blocks in the block diagrams or operational illustrations, may be implemented by means of analog or digital hardware and computer program instructions. These computer program instructions may be stored on computer-readable media and provided to a processor of an ASIC, general-purpose computer, special purpose computer, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

At least some aspects disclosed can be embodied, at least in part, in software. That is, the techniques may be carried out in a special purpose or general-purpose computer system or other data processing system in response to its processor, such as a microprocessor, executing sequences of instructions contained in a memory/data store, such as ROM, volatile RAM, non-volatile memory, cache or a remote storage device. Functions expressed in the claims may be performed by a processor in combination with memory storing code and should not be interpreted as means-plus-function limitations.

Routines executed to implement the embodiments may be implemented as part of an operating system, firmware, ROM, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine-readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

As used herein, and especially within the claims, ordinal terms such as first and second are not intended, in and of themselves, to imply sequence, time or uniqueness, but rather are used to distinguish one claimed construct from another. In some uses where the context dictates, these terms may imply that the first and second are unique. For example, where an event occurs at a first time, and another event occurs at a second time, there is no intended implication that the first time occurs before the second time. However, where the further limitation that the second time is after the first time is presented in the claim, the context would require reading the first time and the second time to be unique times. Similarly, where the context so dictates or permits, ordinal terms are intended to be broadly construed so that the two identified claim constructs can be of the same characteristic or of different characteristic.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention. The above description and drawings are merely illustrative of the present invention and that changes in components, structure and procedure are possible without departing from the scope of the present invention as defined in the following claims. For example, elements and/or steps described above and/or in the following claims in a particular order may be practiced in a different order without departing from the invention. Thus, while the invention has been particularly shown and described with reference to embodiments thereof, it will be understood by those skilled in the art that various changes in form and details may be made therein without departing from the spirit and scope of the invention.

What is claimed is:

1. A system for receiving and automatically distributing sales leads, comprising:
a) a data store including registered user data and sales lead data; and
b) a computer processor coupled to the data store and in communication through the Internet with a user device and programmed, upon receiving an indication from a referral agent that sales lead data is to be uploaded, to:
i) serve a sales lead form via a web page or mobile application page to the referral agent via the Internet, the sales lead form comprising a plurality of data fields describing at least an identification of a prospective customer, an identification of goods or services to be purchased, and an identification of a geographic location of the prospective customer;
ii) receive and store in the data store sales lead data provided by the user via the sales lead form;
iii) automatically identify at least one sales agent to which the sales lead data is to be distributed;
iv) automatically distribute, via the Internet, the sales lead data to the at least one sales agent identified;
v) track at least one sale associated with the sales lead data; and,
vi) display at least one indication to a user that a sale of goods or services associated with the sales lead data has been made.

2. The system for receiving and automatically distributing sales leads according to claim 1, wherein the processor is programmed to automatically identify said at least one sales agent using at least a calculation of proximity of the sales agent to the geographic location of the prospective customer.

3. The system for receiving and automatically distributing sales leads according to claim 1, wherein the processor is programmed to automatically identify said at least one sales agent using data reflecting at least a conversion ratio associated with the sales agent.

4. The system for receiving and automatically distributing sales leads according to claim 1, wherein the processor is programmed to automatically identify said at least one sales agent by determining a highest performing sales agent within a particular geographic area.

5. The system for receiving and automatically distributing sales leads according to claim 1, wherein the processor is programmed to automatically identify said at least one sales agent using past performance data associated with a plurality of sales agents.

6. The system for receiving and automatically distributing sales leads according to claim 1, wherein the processor is programmed to automatically identify said at least one sales agent using data reflecting a number of sales closed by the agent within a given time period.

7. The system for receiving and automatically distributing sales leads according to claim 1, wherein the processor is programmed to automatically identify said at least one sales agent using an online auction system wherein users can bid for leads.

8. The system for receiving and automatically distributing sales leads according to claim 1, wherein the processor is further programmed to receive and store in the data store sales lead data provided by the user via a sales lead data file uploaded to the system, the sales lead data file containing sales lead data for a plurality of sales leads.

9. The system for receiving and automatically distributing sales leads according to claim 7, wherein the sales lead data file is a spreadsheet file.

10. The system for receiving and automatically distributing sales leads according to claim 7, wherein the sales lead data file is a database file.

11. The system for receiving and automatically distributing sales leads according to claim 1, wherein the processor is further programmed to interface with referral agents and with sales agents using both a website portal and a mobile application.

12. The system for receiving and automatically distributing sales leads according to claim 1, wherein the processor is further programmed to determine sharing of sales revenue from said sale of goods or services between a plurality of users of the system.

13. The system for receiving and automatically distributing sales leads according to claim 11, wherein the processor is further programmed to determine sharing of sales revenue among the sales agent, the company employing the sales agent, and the referral agent.

14. The system for receiving and automatically distributing sales leads according to claim 12, wherein the processor is further programmed to determine sharing of sales revenue among at least one of: a company employing the referral agent, a company operating the presently disclosed system, a third party associated with the referral agent, and a third party associated with the sales agent.

15. The system for receiving and automatically distributing sales leads according to claim 1, wherein the processor is further programmed to provide a registration process that allows new users to register to become referral agents.

16. The system for receiving and automatically distributing sales leads according to claim 14, wherein the registration process includes a step of acceptance of an applicant as a registered referral agent.

17. The system for receiving and automatically distributing sales leads according to claim 14, wherein the registration process includes providing to the applicant, via the internet, the capability to upload documentation supporting the applicant's credentials to become a registered referral agent.

18. The system for receiving and automatically distributing sales leads according to claim 1, wherein the processor is further programmed to provide a registration process that allows new users to register to become sales agents.

19. The system for receiving and automatically distributing sales leads according to claim 17, wherein the registration process includes a step of acceptance of an applicant as a registered sales agent.

20. The system for receiving and automatically distributing sales leads according to claim 17, wherein the registration process includes providing to the applicant, via the internet, the capability to upload documentation supporting the applicant's credentials to become a registered sales agent.

21. The system for receiving and automatically distributing sales leads according to claim 19, wherein the processor is further programmed to designate the applicant as a trainee and, after successful completion of training, to promote said applicant to sales agent.

22. The system for receiving and automatically distributing sales leads according to claim 20, wherein the processor is programmed to promote said applicant to sales agent automatically.

23. The system for receiving and automatically distributing sales leads according to claim 20, wherein the processor is programmed to promote said applicant to sales agent with administrator intervention.

24. The system for receiving and automatically distributing sales leads according to claim 1, wherein the processor is further programmed to provide an online shopping mall which allows users to purchase new equipment or services.

25. The system for receiving and automatically distributing sales leads according to claim 23, wherein the new equipment is equipment associated with the sales lead.

26. The system for receiving and automatically distributing sales leads according to claim 23, wherein the services are services associated with the sales lead.

27. The system for receiving and automatically distributing sales leads according to claim 1, wherein the processor is further programmed to provide a price matrix that receives a plurality of parameters from a sales agent and allows the sales agent to formulate rates to be negotiated with at least one merchant.

28. The system for receiving and automatically distributing sales leads according to claim 1, wherein the processor is further programmed to provide a price matrix that receives a plurality of parameters from a merchant and allows the merchant to receive a rate quote for at least one level of service.
